(19) United States
(12) Patent Application Publication
(10) Pub. No.: US 2024/0178551 A1
(43) Pub. Date: May 30, 2024

(54) CELLULAR BASE STATION ANTENNA AND POLE ASSEMBLY

(71) Applicant: CommScope Technologies LLC, Claremont, NC (US)

(72) Inventors: Maosheng Liu, Suzhou (CN); Shida Wang, Suzhou (CN); PuLiang Tang, Suzhou (CN); Hangsheng Wen, Suzhou (CN)

(21) Appl. No.: 18/517,094

(22) Filed: Nov. 22, 2023

(30) Foreign Application Priority Data
Nov. 30, 2022 (CN) 202211521524.6

(51) Int. Cl. H01Q 1/24; H01Q 1/12; H01Q 1/42; H01Q 19/10

(52) U.S. Cl. CPC H01Q 1/246; H01Q 1/1242; H01Q 1/42; H01Q 19/104

(57) ABSTRACT

The present application relates to a cellular base station antenna, including: a radome having a lateral recess that defines a first accommodating space with a lateral opening and for accommodating a pole, where the cellular base station antenna should be mounted to the pole; and an antenna assembly mounted within a second accommodating space defined by the radome, the antenna assembly including a reflecting plate and a radiating element mounted on the reflecting plate. Moreover, the present application relates to a pole assembly, including a pole and a cellular base station antenna capable of being mounted laterally to the pole.

### RELATED APPLICATION

The present application claims priority from and the benefit of Chinese Patent Application 202211521524.6, filed Nov. 30, 2022, the disclosure of which is hereby incorporated herein by reference in full.

### TECHNICAL FIELD

The present application generally relates to the field of antennas, and more particularly, to a cellular base station antenna that can be mounted laterally to a pole and a pole assembly that includes the cellular base station antenna.

### BACKGROUND

As demands for wireless data services grow, the traditional response is to increase the number and capacity of traditional cellular base station antennas (macrocells). Antennas used in these macrocells are typically mounted on antenna towers. Traditional antenna towers have three or four legs on which the antenna and a matching remote radio unit (RRU) can be mounted. However, in some environments, structures known as “monopole” are used as mounting structures. A monopole is typically used when fewer antennas/RRUs need to be mounted and/or lower height structures are required.

As macrocell sites become increasingly insufficient and the available spectrum limits the amount of additional capacity that can be obtained from a given macrocell, small cell remote radio units (RRU) and antenna combinations have been developed to “fill” underserved or congested areas that would otherwise exist within the macrocell site. Deployment of small cells—especially in urban environments—is expected to continue to grow. Typically, this small cell structure (sometimes referred to as metrocell) is mounted on a monopole.

In some cases, the small cell antenna may be mounted on the top of the pole or on the side of the pole. However, in many cases, it is desirable to mount the small cell antenna in the middle of the pole because the top of the pole needs to be reserved for other devices, such as other antenna devices or lighting devices. FIGS. 1 and 2 show a donut type antenna 100′ mounted in the middle of a pole (here a street light pole). However, the donut type antenna 100′ may only slide down from the top of the pole to be mounted in the middle of the pole. This mounting method of sliding downward from the top of the pole may not be possible in some cases. Accordingly, it may be desirable to provide an alternative solution for mounting an antenna on a monopole.

### SUMMARY

Therefore, the objective of the present application is to provide a cellular base station antenna and a pole assembly capable of overcoming at least one drawback in the prior art.

According to a first aspect of the present application, a cellular base station antenna is provided, including: a radome having a lateral recess that defines a first accommodating space with a lateral opening and for accommodating a pole, where the cellular base station antenna should be mounted to the pole; and an antenna assembly mounted within a second accommodating space defined by the radome, the antenna assembly including a reflecting plate and a radiating element mounted on the reflecting plate.

In some embodiments, the cellular base station antenna further comprises a cover body, and the cover body is configured to be detachably mounted to the lateral recess of the radome so as to cover the lateral opening.

In some embodiments, the radome is configured as an integral columnar structure with a lateral recess.

In some embodiments, the lateral recess is a U-shaped recess.

In some embodiments, the radome and the cover body form a cylindrical structure.

In some embodiments, the cover body is configured to be joined to the lateral recess of the radome in a form-fitting manner.

In some embodiments, the radome has joint parts, and the cover body has mating parts for joining to the joint parts.

In some embodiments, the joint parts of the radome are respectively provided on both sides of the radome adjacent to the lateral opening.

In some embodiments, the joint part is configured as a joint groove, and the mating part is configured as a joint rib.

In some embodiments, the joint part is configured as a joint rib, and the mating part is configured as a joint groove.

In some embodiments, the cellular base station antenna further includes an end cover, the end cover includes a base surface and an apron bent from an outer edge of the base surface, the base surface has a lateral groove corresponding to a contour of the lateral recess of the radome, the base surface is configured to cover the radome on an end side, and the apron is configured to abut against the radome on a peripheral side.

In some embodiments, the antenna assembly includes a support structure, and a plurality of reflecting plates are fixed on the support structure.

In some embodiments, the support structure includes a base surface with a plurality of prismatic edges and a side surface bent from a corresponding prismatic edge of the base surface, the base surface of the end cover is fixed to the base surface of the support structure via a fastening device, and a corresponding reflecting plate is fixed to a side surface of the support structure via the fastening device.

In some embodiments, the antenna assembly includes a dielectric plate, and the dielectric plate is fixed between the side surface of the support structure and the corresponding reflecting plate.

In some embodiments, the plurality of reflecting plates include a first reflecting plate and a second reflecting plate on both sides of the lateral recess, and the first reflecting plate and the second reflecting plate are spaced apart from each other by the lateral recess, thereby forming a reflection interruption.

In some embodiments, the cellular base station antenna further includes a reflection patch, and the reflection patch is configured to at least partially compensate for the reflection interruption.

In some embodiments, the reflection patch is fixed on an inner surface of the cover body.

In some embodiments, the reflection patch includes a fixed section fixed on the inner surface of the cover body and first coupling sections extending from one end of the fixed section towards the first accommodating space, respectively.

In some embodiments, the first reflecting plate and the second reflecting plate respectively have second coupling sections close to the lateral recess.

In some embodiments, the first coupling section of the reflection patch and the second coupling section of the corresponding reflecting plate are fixed on two opposite sides of the same wall section of the lateral recess.

In some embodiments, the wall section of the lateral recess is formed with a first joint groove on a first side surface facing the first accommodating space, and the wall section of the lateral recess is formed with a second joint groove on a second side surface facing away from the first accommodating space, where the first joint groove is configured to join to the first coupling section of the reflection patch, and the second joint groove is configured to join to the second coupling section of the corresponding reflecting plate.

In some embodiments, the first coupling section and the corresponding second coupling section at least partially overlap.

In some embodiments, the plurality of reflecting plates and reflection patch form a substantially closed polygonal reflection outline.

In some embodiments, the bottom of the lateral recess of the radome is configured to at least partially abut against a peripheral wall of the pole.

According to a second aspect of the present application, a pole assembly is provided, including a pole; and a cellular base station antenna capable of being mounted laterally to the pole, the cellular base station antenna being configured as the cellular base station antenna according to some embodiments of the present application.

In some embodiments, the cellular base station antenna is configured to be mounted to the middle of the pole.

In some embodiments, a lighting device is mounted on the top of the pole.

### BRIEF DESCRIPTION OF THE ATTACHED DRAWINGS

FIG. 1 is a perspective view of an exemplary donut type antenna.

FIG. 2 is a front view of an exemplary monopole with a lighting device mounted on the top side of the monopole and a donut type antenna shown in FIG. 1 mounted in the middle of the monopole.

FIG. 3 is a perspective view of an antenna according to some embodiments of the present application, where the antenna is mounted in the middle of a monopole.

FIG. 4 is a perspective view of the antenna of FIG. 3 after an end cover is removed.

FIG. 5 is an exploded view of the antenna of FIG. 3.

FIG. 6 is a simplified end view of an antenna according to some embodiments of the present application after an end cover is removed.

FIG. 7 is a partially enlarged view of the end view of FIG. 6.

FIG. 8a is a view of a radome of the antenna of FIG. 3.

FIG. 8b is a view of an end cover of the antenna of FIG. 3.

FIG. 9 is a simplified perspective view of an antenna assembly of the antenna of FIG. 3, where a radiating element mounted on a reflecting plate is removed.

FIG. 10 is a support structure for fixing a plurality of reflecting plates in the antenna assembly of FIG. 9.

FIG. 11 is a cross-sectional view of the antenna assembly of FIG. 9, showing a fixing method between a support structure and a reflecting plate.

FIG. 12a is a view of a reflecting plate of the antenna of FIG. 3.

FIG. 12b is a view of a reflection patch of the antenna of FIG. 3.

FIG. 12c is a view of a cover body of the antenna of FIG. 3.

FIG. 13 is an end view of an antenna assembly of an antenna according to alternative embodiments of the present application.

FIGS. 14a and 14b are perspective views, respectively, of an exemplary mounting part for mounting an antenna to a monopole according to some embodiments of the present application.

FIGS. 15a, 15b, 15c, and 15d are assembled views of operations for mounting an antenna to a monopole according to some embodiments of the present application.

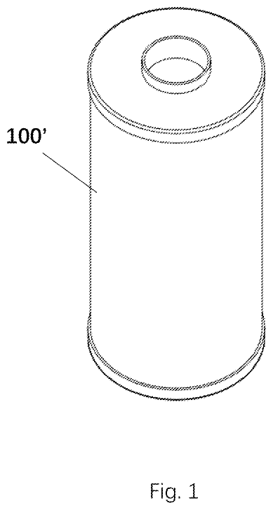

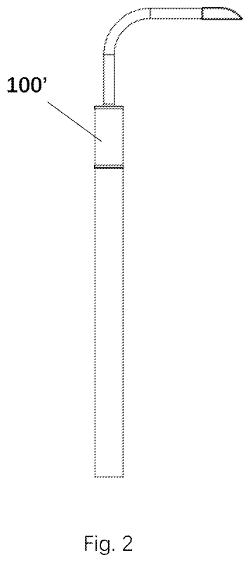

### DETAILED DESCRIPTION

The present application will be described below with reference to the attached drawings, wherein the attached drawings illustrate certain embodiments of the present application. However, it should be understood that the present application may be presented in many different ways and is not limited to the embodiments described below; in fact, the embodiments described below are intended to make the disclosure of the present application more complete and to fully explain the protection scope of the present application to those skilled in the art. It should also be understood that the embodiments disclosed in the present disclosure may be combined in various ways so as to provide more additional embodiments.

It should be understood that the terms used herein are only used to describe specific embodiments, and are not intended to limit the scope of the present application. All terms used herein (including technical terms and scientific terms) have meanings normally understood by those skilled in the art unless otherwise defined. For brevity and/or clarity, well-known functions or structures may not be further described in detail.

As used herein, spatial relationship terms such as “upper”, “lower”, “left”, “right”, “front”, “back”, “high”, and “low” can explain the relationship between one feature and another in the attached drawings. It should be understood that, in addition to the orientations shown in the attached drawings, the terms expressing spatial relations also comprise different orientations of a device in use or operation. For example, when a device in the attached drawings rotates reversely, the features originally described as being “below” other features now can be described as being “above” the other features. The device may also be oriented by other means (rotated by 90 degrees or at other locations), and at this time, a relative spatial relation will be explained accordingly.

As used herein, the term “A or B” comprises “A and B” and “A or B”, not exclusively “A” or “B”, unless otherwise specified.

As used herein, the term “schematic” or “exemplary” means “serving as an example, instance or explanation”, not as a “model” to be accurately copied. Any realization method described exemplarily herein may not be necessarily interpreted as being preferable or advantageous over other realization methods. Furthermore, the present application is not limited by any expressed or implied theory given in the above technical field, background art, summary of the invention or embodiments.

As used herein, the word “basically” means including any minor changes caused by design or manufacturing defects, device or component tolerances, environmental influences, and/or other factors.

As used herein, the term “partially” may be a part of any proportion. For example, it may be greater than 10%, 20%, 30%, 40%, 50%, 60%, 70%, 80%, 90%, or may even be 100%, i.e. all.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

According to the present application, a cellular base station antenna that can be mounted laterally on a pole, such as a monopole, is provided and includes a radome having a lateral recess that defines a first accommodating space with a lateral opening and for accommodating a pole; and an antenna assembly mounted within a second accommodating space defined by the radome, the antenna assembly including a reflecting plate and a radiating element mounted on the reflecting plate.

When the lateral opening of the cellular base station antenna is moved laterally towards the monopole, the monopole can easily enter into the first accommodating space via the lateral opening and be securely received at the bottom of the lateral recess. The cellular base station antenna may then be securely mounted to the monopole by means of a suitable fastening device, thereby allowing lateral mounting of the cellular base station antenna on any desired section or height of the monopole, such as the middle section.

Advantageously, the cellular base station antenna may further include a cover body, and the cover body may be configured to be detachably mounted to the lateral recess of the radome so as to cover the lateral opening. As such, the cellular base station antenna may have a substantially closed generally cylindrical outline.

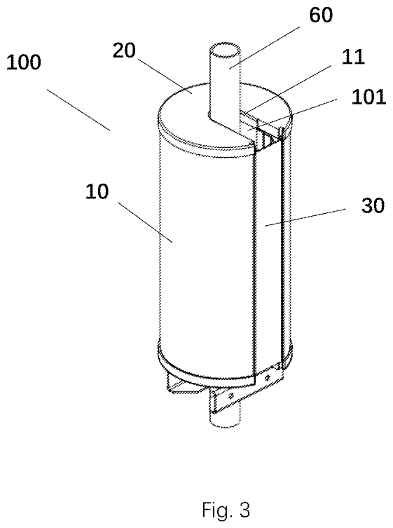

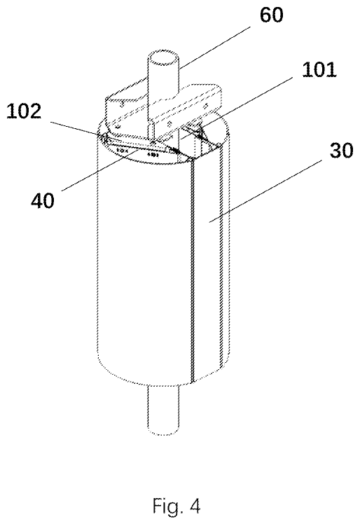

Referring now to FIGS. 3-5, a partial portion of a monopole 60 and a cellular base station antenna 100 mounted on the monopole 60 are shown therein. The cellular base station antenna 100 may include a radome 10, an end cover 20 (upper end cover and lower end cover), a cover body 30 (side cover body), and an antenna assembly 40.

As shown in FIGS. 3-5, the monopole 60 may be accommodated within a first accommodating space 101 defined by a lateral recess 11 of the radome 10 and located externally relative to the radome 10. The antenna assembly 40 may be accommodated within a second accommodating space 102 defined by the radome 10 and located inside relative to the radome 10. The first and second accommodating spaces 101, 102 may be isolated from each other via a wall section of the radome 10 forming the lateral recess 11. As such, the first and second accommodating spaces 101, 102 may be configured as relatively separate accommodating spaces from each other. For example, the antenna assembly 40 may be mounted into the second accommodating space 102 in advance, and then the monopole 60 may be accommodated into the first accommodating space 101.

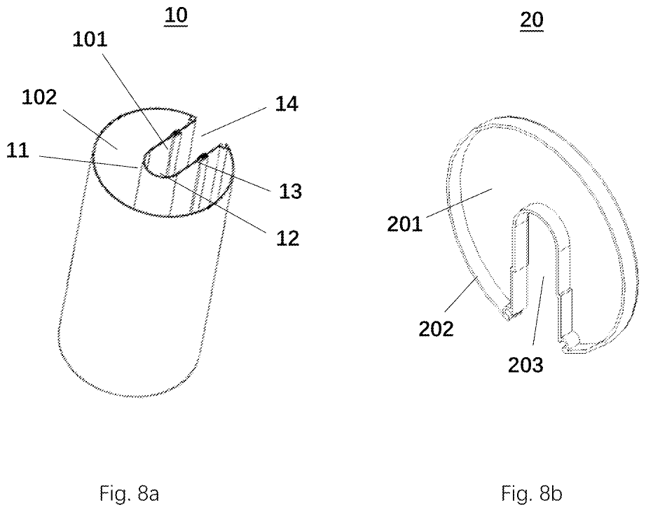

Referring to FIGS. 8a and 8b, perspective views of an exemplary radome 10 and end cover 20 are shown, respectively.

Unlike the cylindrical radome of the traditional donut type antenna 100′, the radome 10 of the antenna 100 of the present application is no longer a complete cylinder, but a columnar structure with the lateral recess 11. “The lateral recess 11” may be understood as a bent structure portion of the radome 10 that is recessed from the outside towards the inside.

The radome 10 is typically formed from a material that enables signals to enter and exit from the antenna. Exemplary materials of the radome 10 may include polymeric materials such as PVC, glass fibers, fiber reinforced polypropylene, acrylonitrile styrene acrylate (ASA), and polycarbonate. By casting, the radome 10 may be configured as an integral columnar structure.

The lateral recess 11 of the radome 10 may be configured as a substantially U-shaped recess. The first accommodating space 101 may be configured as a substantially U-shaped accommodation groove. It should be understood that “U-shaped” does not mean that the shape is strictly identical with the letter “U”, but rather means that the lateral recess 11 has one bottom section 12 and two wall sections 13 extending outwardly from the bottom section, thereby forming a generally U-shaped outline.

In some embodiments, the bottom section 12 of the lateral recess 11 may be flat, arcuate or stepped. In some embodiments, the two wall sections 13 of the lateral recess 11 may be flat or may be stepped. In some embodiments, the two wall sections 13 of the lateral recess 11 may also have different configuration and/or angular orientations in order to avoid specific components.

Advantageously, the outline of the bottom section 12 of the U-shaped recess may substantially correspond to the peripheral wall outline of the monopole 60, so that the peripheral wall of the monopole 60 can more securely abut or confront the bottom of the lateral recess 11. When the monopole 60 is a cylindrical monopole 60, the bottom section 12 of the U-shaped recess may have a circularly curved cross-section. When the monopole 60 is a prismatic monopole 60, the bottom section 12 of the U-shaped recess may have a linear or angled cross-section.

As shown in FIGS. 3 and 8b, the cellular base station antenna 100 may include an end cover 20 (upper end cover and lower end cover) that may cover the radome 10 on the end side so as to surround the radome 10 on the end side and thereby close the second accommodating space 102 defined by the radome 10. The end cover 20 may include a base surface 201 and an apron 202 bent from an outer edge of the base surface 201. Advantageously, the base surface 201 may extend substantially horizontally, while the apron 202 extends substantially perpendicular to the base surface 201. The base surface 201 of the end cover 20 may be configured with a lateral groove 203 corresponding to the outline of the lateral recess 11 of the radome 10. The apron 202 of the end cover 20 may be configured to abut the outer periphery of the radome 10 on the peripheral side. Advantageously, the end cover 20 may be secured with the radome 10 via suitable fastening measures. Possible fastening measures may include, but are not limited to: bonding, form-fitting, threading, welding, etc.

In some embodiments, for aesthetic reasons, the cellular base station antenna 100 and a matching RRU module (not shown in the figure) may be hidden into a substantially cylindrical shield (not shown in the figure), which can cover and hide the cellular base station antenna 100 and RRU module. In some cases, the end cover 20 and/or the cover body 30 mentioned in the present application may be omitted in view of the presence of the shield.

Referring to FIGS. 6, 7, and 9, there is shown a simplified end view of the antenna 100 according to some embodiments of the present application and a partial enlarged view thereof after the end cover 20 is removed.

The antenna assembly 40 may be mounted in the second accommodating space 102 within the radome 10, and the antenna assembly 40 may include a support structure 41, a plurality of reflecting plates 42 mounted at a plurality of prismatic edges of the support structure 41, and a radiating element array 43 mounted on the plurality of reflecting plates 42.

In the illustrated embodiment, the cellular base station antenna 100 may have a “three-sector” configuration in which one cell is divided into three 120° sectors in the azimuth plane. As shown in FIG. 6, the antenna assembly 40 may include three reflecting plates 42, and orientations of two adjacent reflecting plates 42 may be approximately 120° apart from each other, so as to provide coverage for the three corresponding sectors.

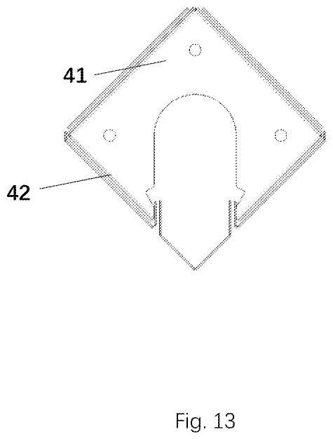

It should be understood that the sector configuration of the cellular base station antenna 100 may have a variety of feasible variations. In some embodiments, the antenna assembly 40 may include fewer than three reflecting plates 42. In some embodiments, the antenna assembly 40 may include more than three reflecting plates 42, for example, it may have four reflecting plates 42 (as shown in FIG. 13), five reflecting plates 42, or even six reflecting plates 42.

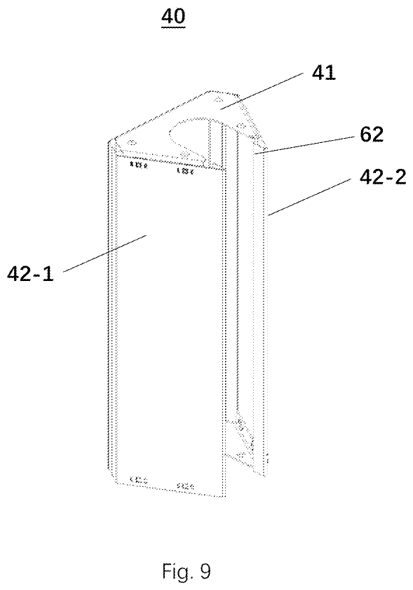

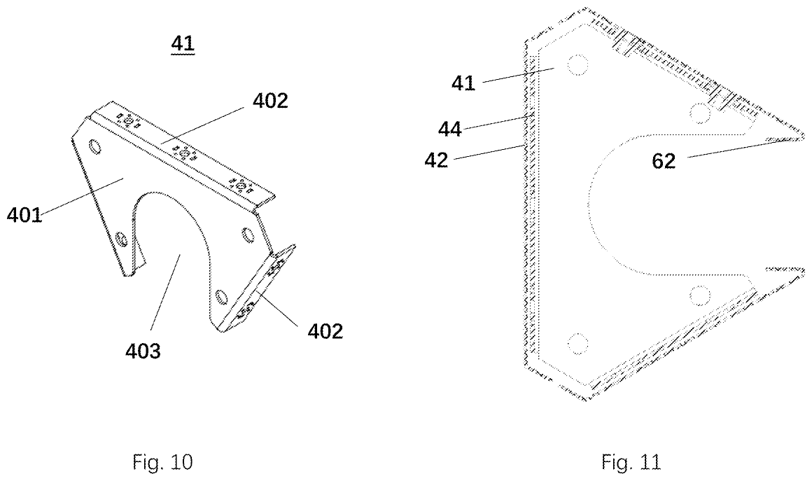

Referring to FIG. 9, a simplified perspective view of the antenna assembly 40 is shown in which the radiating element mounted on the reflecting plate 42 is removed. Referring to FIG. 10, an exemplary perspective view of the support structure 41 in the antenna assembly 40 for fixing the plurality of reflecting plates 42 is shown.

As shown in FIG. 10, the support structure 41 may include a base surface 401 with a plurality of prismatic edges and a side surface 402 bent from the prismatic edge of the base surface. Advantageously, the base surface 401 may extend substantially horizontally, while the side surface 402 extends substantially perpendicular to the base surface 401. The base surface 401 of the support structure 41 may be configured to have a lateral groove 403 corresponding to the outline of the lateral recess 11 of the radome 10, thereby effectively avoiding interference with the radome 10 at the lateral recess 11. Further, the base surface of the support structure 41 may be secured with the end cover 20 via a fastening device (e.g., rivets or screws). The side surface 402 of the support structure 41 may be secured with the corresponding reflecting plate 42 via a fastening device (e.g., rivets or screws). This ensures stable mounting of the antenna assembly 40.

When the support structure 41 is a metal member, direct contact between the metal support structure 41 and the reflecting plate 42 (typically an aluminum reflecting plate 42) may deteriorate passive intermodulation (PIM) performance of the cellular base station antenna 100. In order to avoid direct contact between the support structure 41 and the reflecting plate 42, the antenna assembly 40 may include a dielectric plate 44, which is fixed between the side surface 402 of the support structure 41 and the corresponding reflecting plate 42, as shown in FIG. 11.

With continued reference to FIGS. 6 and 9, the plurality of reflecting plates 42 cannot form a substantially continuous reflection outline due to the presence of the lateral recess 11, but instead have localized reflection interruptions. As shown in FIG. 9, the first and second reflecting plates 42-1, 42-2 are spaced apart by the lateral recess 11, so there is an undesirable reflection interruption between the first and second reflecting plates 42-1, 42-2 on both sides of the lateral recess 11.

In order to at least partially overcome the problem caused by the reflection interruption, the cellular base station antenna 100 may further include a reflection patch 50, which may be configured as a metal sheet metal member. Advantageously, the reflection patch 50 may be fixed on the cover body 30. Thus, when the cover body 30 is mounted at the lateral recess 11 of the radome 10, the reflection patch 50 may be mounted in place so as to provide favorable reflection compensation.

Next, the cover body 30 of the cellular base station antenna 100 and the reflection patch 50 are described in further detail with reference to FIGS. 3, 5-7, and 12a-12c.

The cover body 30 may be configured as a lateral cover plate for covering the lateral opening 14 brought by the lateral recess 11, which may be configured to be detachably mounted to the lateral recess 11 of the radome 10. As shown in FIGS. 3 and 6, when the cover body 30 is mounted to the radome 10, the cellular base station antenna 100 may be in a substantially closed cylindrical structure. This is advantageous not only in terms of aesthetic appearance but also in terms of water and dust resistance.

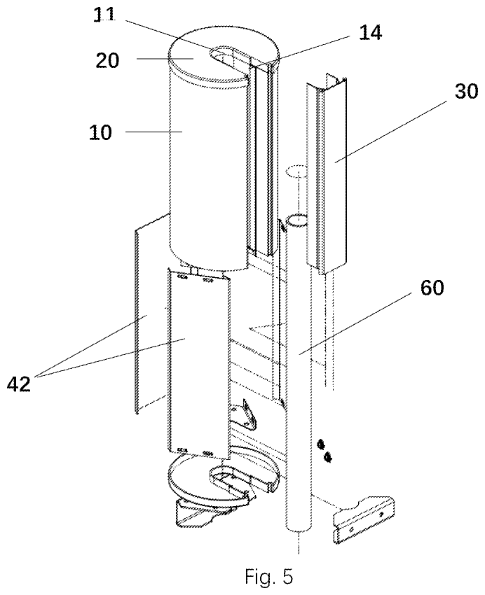

As shown in FIGS. 5, 7 and 12c, the cover body 30 may be configured to be joined to the lateral recess 11 of the radome 10 in a form-fitting manner. The radome 10 may have joint parts 12, and the cover body 30 may have mating parts 32 for joining to the joint parts 12. The joint parts 12 of the radome 10 may be respectively provided on both sides of the radome 10 near the lateral opening 14, and the mating parts 32 of the radome 30 may be respectively provided on both sides of the radome 30. In the illustrated embodiment, the joint part 12 of the radome 10 may be configured as a joint groove, and the mating part 32 on the cover body 30 may be configured as a joint rib. As such, a stable connection between the two can only be achieved by embedding the joint rib on the cover body 30 into the joint groove of the radome 10.

It should be understood that the detachable connection method may have a variety of possibilities and is not limited to the above-mentioned methods. In some embodiments, the joint part 12 of the radome 10 may be configured as a joint rib, and the mating part 32 on the cover body 30 may be configured as a joint groove. In other embodiments, the connection between the radome 10 and the cover body 30 may be achieved via a threaded connection, a snap connection, bonding, and/or a hinge connection.

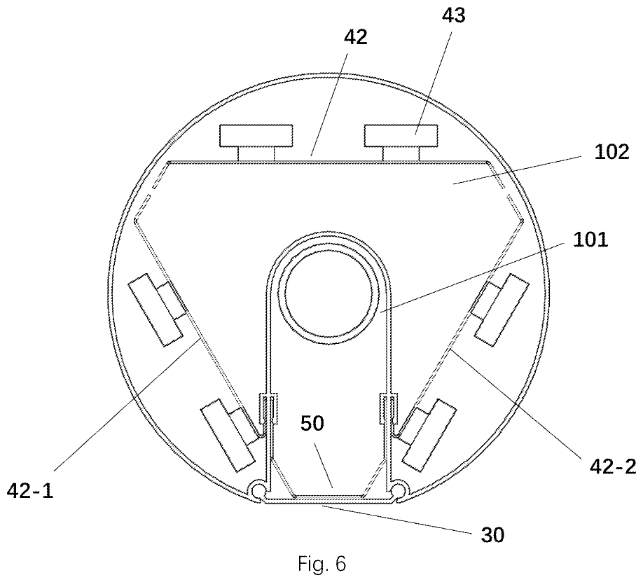

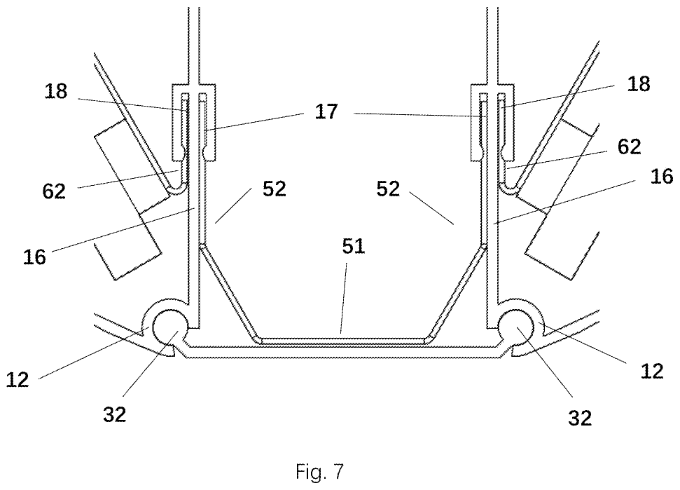

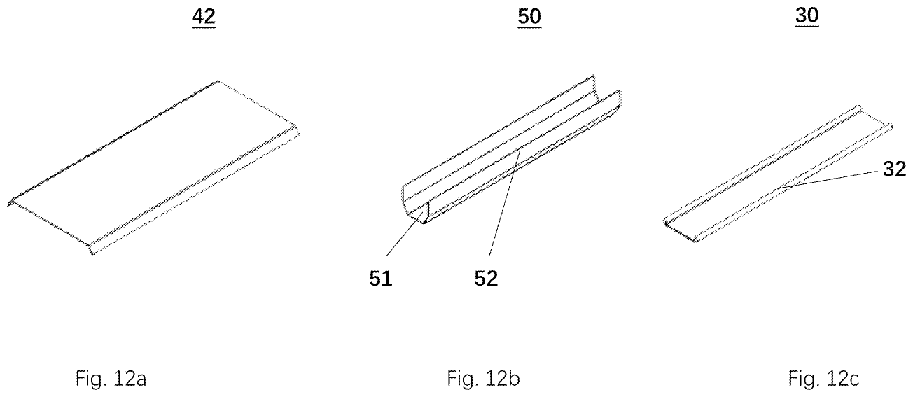

With continued reference to FIGS. 7 and 12b, the reflection patch 50 may be secured to an inner surface of the cover body 30. The reflection patch 50 may have a fixed section 51 fixed on the inner surface of the cover body 30 and first coupling sections 52 extending inwardly (i.e., towards the first accommodating space 101) from one end of the fixed section 51, respectively. Advantageously, the reflection patch 50 may be secured with the cover body 30 via suitable fastening measures. Possible fastening measures may include, but are not limited to: bonding, form-fitting, threading, welding, etc.

In order to form a substantially continuous reflection outline, a path may be coincident between the reflection patch 50 and the first and second reflecting plates 42-1, 42-2 on both sides of the lateral recess 11. As shown in FIGS. 6 and 7, the first and second reflecting plates 42-1, 42-2 respectively have second coupling sections 62 close to the lateral recess 11, and the first coupling section 52 of the reflection patch 50 may at least partially overlap the second coupling section 62 of the corresponding reflecting plate 42.

Advantageously, the first coupling section 52 of the reflection patch 50 and the second coupling section 62 of the corresponding reflecting plate 42 may be fixed on two opposite sides of a same wall section 16 of the lateral recess 11.

In order to fix the first coupling section 52 of the reflection patch 50, the wall section 16 of the lateral recess 11 may be formed with a first joint groove 17 on a first side surface facing the first accommodating space 101, and the first joint groove 17 may be configured to embed into the first coupling section 52 of the reflection patch 50. In addition, in order to fix the second coupling sections 62 of the first and second reflecting plates 42-2, the wall section 16 of the lateral recess 11 may be formed with a second joint groove 18 on a second side surface facing away from the first accommodating space 101 (or otherwise facing towards the second accommodating space 102), and the second joint groove 18 may be configured to embed into the second coupling section 62 of the corresponding reflecting plate 42. Advantageously, the first and second joint grooves 17, 18 may be substantially shaped on both sides of the same location of the lateral recess 11, thereby achieving good coupling between the reflection patch 50 and the reflecting plate 42.

It should be understood that the corresponding coupling section may be fixed in a variety of ways and is not limited to the above-mentioned methods. In other embodiments, the fixing of the corresponding coupling section may also be achieved through bonding, form-fitting, a snap connection, a threaded connection, welding, etc.

As such, the plurality of reflecting plates 42 and the reflection patch 50 may generally form a substantially closed polygonal reflection outline. The substantially closed polygonal reflection outline is advantageous in that it provides a larger ground plane for the radiating element array and improves the pattern of antenna beam emitted by the radiating element array.

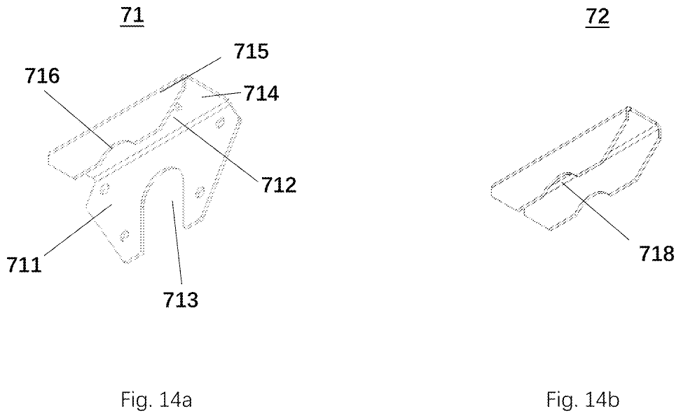

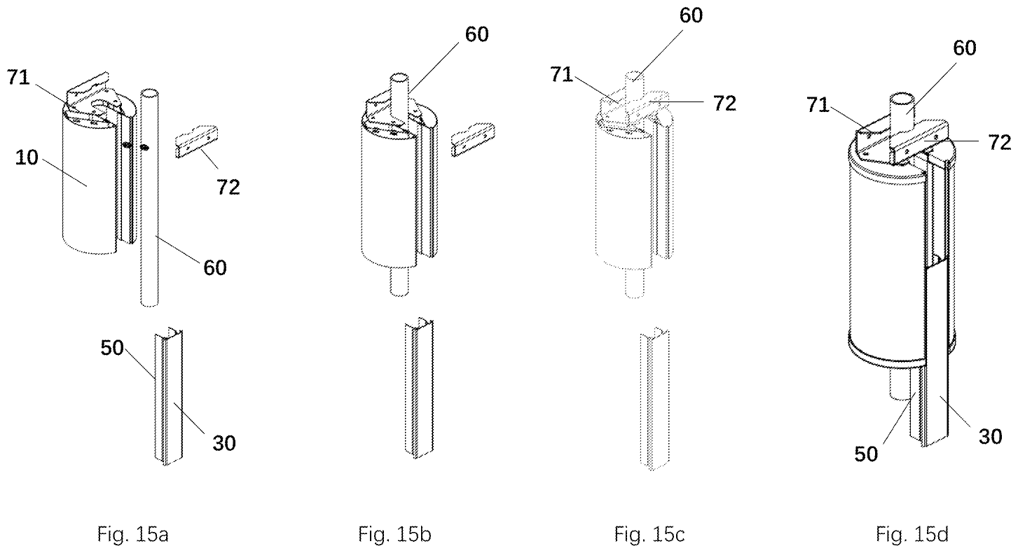

Next, assembly steps for mounting the antenna to the monopole 60 according to some embodiments of the present application are described with reference to FIGS. 14a, 14b, 15a, 15b, 15c, and 15d.

As shown in FIG. 15a, the radome 10 together with the antenna assembly 40 mounted within the radome 10 may be provided as a whole. A first mounting part 71 (as shown in FIG. 14a) may be provided on the end cover 20 (not shown in the figure), and the first mounting part 71 may include a base surface 711 and an abutting structure 712 bent from the edge of the base surface 711. The base surface 711 may have a lateral groove 713 corresponding to the outline of the lateral recess 11 of the radome 10. In order to ensure reliable fixation of the antenna assembly 40, the base surface 401 of the support structure 41 of the antenna assembly 40 may be fixed to the base surface 201 of the end cover 20 and the base surface 711 of the first mounting part 71 via a fastening device, such as a threaded connector. The abutting structure 712 of the first mounting part 71 may have a first section 714 that extends from the edge of the base surface and that is substantially perpendicular to the base surface and a second section 715 that is bent relative to the first section. The second section 715 may have an accommodating recess 716 for abutting the monopole 60.

To implement assembly, the lateral opening 14 of the radome 10 may move towards the monopole 60 such that the monopole 60 can enter the first accommodating space 101 defined by the lateral recess 11 via the lateral opening 14. As shown in FIG. 15b, the peripheral wall of the monopole 60 may abut on the bottom of the U-shaped lateral recess 11. In addition, the lateral groove 713 of the base surface 711 of the first mounting part 71 and the second section of the L-shaped structure can be advantageously abutted to different positions of the monopole 60, respectively, thereby further improving stable mounting of the antenna on the monopole 60, and thereby having better wind load resistance.

As shown in FIG. 15c, a second mounting part 72 (as shown in FIG. 14b) for use with the first mounting part 71 may also be provided, and the first mounting part 71 and the second mounting part 72 may be fastened to each other via a fastening device, such as a threaded connection device. The second mounting part 72 may have an accommodating recess 718 for abutting on the monopole 60. The first mounting part 71 and the second mounting part 72 may be arranged oppositely on both sides of the monopole 60 such that the first mounting part 71 supports the monopole 60 on a first side of the monopole 60 and the second mounting part 72 supports the monopole 60 on a second side of the monopole 60. This further improves stable mounting of the antenna on the monopole 60, thereby having better wind load resistance.

After the radome 10 is securely mounted to the monopole 60, the cover body 30 (advantageously, together with the reflection patch 50) may be connected to the radome 10, as shown in FIG. 15d.

Some embodiments of the present disclosure are exemplary described above in connection with the accompanying drawings. Those skilled in the art should understand that the specific structures shown in the above embodiments are exemplary only and not limiting. Moreover, those skilled in the art can combine the above-described various technical features in a variety of possible ways to form a new technical solution or make other modifications, which are included within the scope of the present disclosure.

What is claimed is:

1. A cellular base station antenna, comprising:
a radome having a lateral recess that defines a first accommodating space with a lateral opening and for accommodating a pole, wherein the cellular base station antenna should be mounted to the pole; and
an antenna assembly mounted within a second accommodating space defined by the radome, the antenna assembly comprising a reflecting plate and a radiating element mounted on the reflecting plate.

2. The cellular base station antenna according to claim 1, wherein the cellular base station antenna further comprises a cover body, and the cover body is configured to be detachably mounted to the lateral recess of the radome so as to cover the lateral opening.

3. The cellular base station antenna according to claim 1, wherein the radome is configured as an integral columnar structure with a lateral recess.

4. The cellular base station antenna according to claim 1, wherein the lateral recess is a U-shaped recess.

5. The cellular base station antenna according to claim 2, wherein the radome and the cover body form a cylindrical structure.

6. The cellular base station antenna according to claim 2, wherein the cover body is configured to be joined to the lateral recess of the radome in a form-fitting manner.

7. The cellular base station antenna according to claim 6, wherein the radome has joint parts, and the cover body has mating parts for joining to the joint parts.

8. The cellular base station antenna according to claim 7, wherein the joint parts of the radome are respectively provided on both sides of the radome adjacent to the lateral opening.

9. The cellular base station antenna according to claim 7, wherein the joint part is configured as a joint groove, and the mating part is configured as a joint rib.

10. The cellular base station antenna according to claim 7, wherein the joint part is configured as a joint rib, and the mating part is configured as a joint groove.

11. The cellular base station antenna according to claim 2, wherein the cellular base station antenna further comprises an end cover, the end cover comprises a base surface and an apron bent from an outer edge of the base surface, the base surface has a lateral groove corresponding to a contour of the lateral recess of the radome, the base surface is configured to cover the radome on an end side, and the apron is configured to abut against the radome on a peripheral side.

12. The cellular base station antenna according to claim 11, wherein the antenna assembly comprises a support structure, and a plurality of reflecting plates are fixed on the support structure.

13. The cellular base station antenna according to claim 12, wherein the support structure comprises a base surface with a plurality of prismatic edges and a side surface bent from a corresponding prismatic edge of the base surface, the base surface of the end cover is fixed to the base surface of the support structure via a fastening device, and a corresponding reflecting plate is fixed to a side surface of the support structure via the fastening device.

14. The cellular base station antenna according to claim 12, wherein the plurality of reflecting plates comprise a first reflecting plate and a second reflecting plate on both sides of the lateral recess, and the first reflecting plate and the second reflecting plate are spaced apart from each other by the lateral recess, thereby forming a reflection interruption.

15. The cellular base station antenna according to claim 14, wherein the cellular base station antenna further comprises a reflection patch, and the reflection patch is configured to at least partially compensate for the reflection interruption.

16. The cellular base station antenna according to claim 15, wherein the reflection patch is fixed on an inner surface of the cover body.

17. The cellular base station antenna according to claim 1, wherein the bottom of the lateral recess of the radome is configured to at least partially abut against a peripheral wall of the pole.

18. A pole assembly, comprising:
a pole; and
a cellular base station antenna capable of being mounted laterally to the pole, the cellular base station antenna being configured as the cellular base station antenna according to claim 1.

19. The pole assembly according to claim 18, wherein the cellular base station antenna is configured to be mounted to the middle of the pole.

20. The pole assembly according to claim 18, wherein a lighting device is mounted on the top of the pole.
